(19) United States
(12) Patent Application Publication
(10) Pub. No.: US 2017/0193515 A1
(43) Pub. Date: Jul. 6, 2017

(54) METHOD FOR DETERMINING IF A CURRENT WALLET-BASED TRANSACTION INITIATED BY A DIGITAL WALLET USER IS FRAUDULENT

(71) Applicant: MasterCard International Incorporated, Purchase, NY (US)

(72) Inventors: Ashutosh SHARAN, Gurgaon (IN); Sheetanshu GUPTA, Jaipur (IN); Mayank PRAKASH, Dehradun (IN)

(21) Appl. No.: 15/395,670

(22) Filed: Dec. 30, 2016

(30) Foreign Application Priority Data
Dec. 31, 2015 (SG) 10201510818R

(51) Int. Cl. G06Q 20/40; G06Q 20/36

(52) U.S. Cl. CPC G06Q 20/4016; G06Q 20/36

(57) ABSTRACT

A computer-implemented method for determining if a current wallet-based transaction initiated by a digital wallet user is fraudulent is provided. The method includes receiving current wallet-based transaction data relating to the current wallet-based transaction, and identifying one or more profile characteristics relating to a digital wallet owner based on the current wallet-based transaction data. The method further includes retrieving historical payment card transaction data based on the identified one or more profile characteristics. The method also includes comparing the current wallet-based transaction data and the historical payment transaction data to determine if the current wallet-based transaction is fraudulent.

### CROSS REFERENCE TO RELATED APPLICATIONS

This application claims the benefit of priority of Singapore Patent Application No. 10201508866S filed Oct. 27, 2015, and Singapore Patent Application No. 10201510818R filed Dec. 31, 2015, which are hereby incorporated by reference in their entirety.

### BACKGROUND

The present disclosure relates broadly, but not exclusively, to methods for determining if a current wallet-based transaction is fraudulent.

Digital wallets allow owners to make payment for purchases using electronic money. Examples of digital wallets are Google wallet, Apple Passbook, Microsoft Wallet which are provided by digital wallet providers, such as Google, Apple, and Microsoft, respectively. Typically, digital wallets are part of mobile payment systems which allow the owners to pay using their mobile devices, such as smart phones. For example, a digital wallet owner may make payment for purchases at a physical store by scanning a barcode or tapping a mobile device to a Near-Field Communication machine. A digital wallet owner may also make payment for online purchases using a computing device. A digital wallet allows for quick and easy transactions. It also allows the digital wallet owner to track his or her spending more easily. Digital wallets are becoming increasingly popular and it is also speculated that physical wallets may soon be replaced by digital wallets.

One of the major problems faced by the digital wallet providers is fraudulent use of the digital wallets. While digital wallets are usually encrypted, a fraudster may trick a digital wallet owner into providing them with sensitive information. This is usually done by the fraudster disguising as a financial institution, such as a digital wallet provider or a bank, requesting for the sensitive information. Since digital wallets may contain the owners' payment card details and the owners' bank accounts may be linked to their digital wallets, fraudulent use of the digital wallets could be detrimental to both the digital wallet providers and the owners.

A need, therefore, exists to provide methods for determining if a current wallet-based transaction is fraudulent that addresses one or more of the above problems.

Furthermore, other desirable features and characteristics will become apparent from the subsequent detailed description and the appended claims, taken in conjunction with the accompanying drawings and this background of the disclosure.

### BRIEF DESCRIPTION

According to a first aspect of the present disclosure, a computer-implemented method for determining if a current wallet-based transaction initiated by a digital wallet user is fraudulent is provided. The method includes receiving current wallet-based transaction data relating to the current wallet-based transaction wherein the current wallet-based transaction data identifies a digital wallet account to be used by the digital wallet user, identifying one or more profile characteristics relating to a digital wallet owner based on the current wallet-based transaction data wherein the digital wallet owner is an owner of the identified digital wallet account, retrieving historical payment card transaction data based on the identified one or more profile characteristics wherein the historical payment card transaction data relates to a plurality of historical payment card transactions for a plurality of payment card owners satisfying all of the identified one or more profile characteristics and indicating a prediction of a purchasing behavior of the digital wallet owner, and comparing the current wallet-based transaction data and the historical payment transaction data to determine if the current wallet-based transaction is fraudulent.

Receiving the current wallet-based transaction data relating to the current wallet-based transaction may further include assigning a fraud score to the current wallet-based transaction, the fraud score indicating a likelihood that the current wallet-based transaction is fraudulent.

Comparing the current wallet-based transaction data and historical payment transaction data to determine if the current wallet-based transaction is fraudulent may further include updating the fraud score when the current wallet-based transaction is determined to be fraudulent.

Comparing the current wallet-based transaction data and historical payment transaction data may further include comparing the fraud score with a predetermined threshold value.

The current wallet-based transaction may be determined to be fraudulent when the fraud score is more than the predetermined threshold value.

The method may further include the steps of obtaining an identity of a merchant with whom the digital wallet user has initiated the current wallet-based transaction, and comparing the identity of the merchant with a list of merchants to determine if the current wallet-based transaction is fraudulent, the list of merchants including merchants who have been identified to be unauthorized to initiate a transaction.

The method may further include the step of updating the fraud score when the current wallet-based transaction is determined to be fraudulent.

The method may further include the steps of determining current product data associated with the current wallet-based transaction, and comparing the current product data with a list of product data to determine if the current wallet-based transaction is fraudulent, the list of product data including products which have been purchased by the digital wallet owner.

The method may further include the step of determining a number of login attempts for the digital wallet account of the digital wallet owner.

The method may further include the steps of identifying a digital wallet device used in the current wallet-based transaction, and comparing the digital wallet device with one or more digital wallet devices to determine if the current wallet-based transaction is fraudulent, the one or more digital wallet devices including devices authorized to initiate a wallet-based transaction on behalf of the digital wallet owner.

The method may further include the steps of when it is determined that the current wallet based transaction is fraudulent, transmitting a verification request to a digital wallet device included in the one or more digital wallet devices, and settling the current wallet based transaction based on a verification input.

According to a second aspect of the present disclosure, an apparatus for determining if a current wallet-based transaction initiated by a digital wallet user is fraudulent is provided. The apparatus includes at least one processor, and at least one memory including computer program code. The at least one memory and the computer program code configured to, with at least one processor, cause the apparatus at least to receive current wallet-based transaction data relating to the current wallet-based transaction wherein the current wallet-based transaction data identifies a digital wallet account to be used by the digital wallet user, identify one or more profile characteristics relating to a digital wallet owner based on the current wallet-based transaction data wherein the digital wallet owner is an owner of the identified digital wallet account, retrieve historical payment card transaction data based on the identified one or more profile characteristics wherein the historical payment card transaction data relates to a plurality of historical payment card transactions for a plurality of payment card owners satisfying all of the identified one or more profile characteristics and indicating a prediction of a purchasing behavior of the digital wallet owner, and compare the current wallet-based transaction data and the historical payment transaction data to determine if the current wallet-based transaction is fraudulent.

According to a third aspect of the present disclosure, a computer-readable storage medium having stored thereon computer program code is provided. The computer program code when executed by a computer causes the computer to execute a method as defined in the first aspect.

### BRIEF DESCRIPTION OF THE DRAWINGS

Embodiments of the disclosure will be better understood and readily apparent to one of ordinary skill in the art from the following written description, by way of example only, and in conjunction with the drawings.

FIG. 1A shows a block diagram of a transaction system within which transaction data can be received.

FIG. 1B shows a block diagram of how a payment network server shown in FIG. 1A may communicate with a fraud determining server in accordance with an embodiment of the disclosure.

FIG. 2A shows a flow chart illustrating a computer-implemented method for predicting purchasing behavior of digital wallet owners satisfying a profile characteristic according to an example embodiment.

FIG. 2B shows a flow chart illustrating a computer-implemented method for determining if a current wallet-based transaction initiated by a digital wallet user is fraudulent according to an example embodiment.

FIG. 3 shows a schematic diagram of a computer system suitable for use in executing the method depicted in FIG. 2B.

FIG. 4 shows an exemplary computing device to realize a server for the fraud determining server shown in FIG. 1B.

### DETAILED DESCRIPTION

Embodiments of the present disclosure will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “determining”, “replacing”, “generating”, “initializing”, “outputting”, “receiving”, “retrieving”, “identifying”, “settling”, “updating”, “comparing” or the like, refer to the action and processes of a computer system, or similar electronic device, that manipulates and transforms data represented as physical quantities within the computer system into other data similarly represented as physical quantities within the computer system or other information storage, transmission, or display devices.

The present specification also discloses apparatus for performing the operations of the methods. Such apparatus may be specially constructed for the required purposes, or may include a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the disclosure.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the preferred method.

Various embodiments of the present disclosure relate to methods for determining if a current wallet-based transaction initiated by a digital wallet user is fraudulent. In an embodiment, the method is a computer-implemented method which determines if a current wallet-based transaction initiated by a digital wallet user is fraudulent by comparing the current wallet-based transaction data and historical payment transaction data.

In the following description, a payment card is a card that can be used by an account holder for a transaction with a merchant. In the following description, the term “payment cards” refer to any suitable transaction cards, such as credit cards, debit cards, prepaid cards, charge cards, membership cards, promotional cards, frequent flyer cards, identification cards, gift cards, and/or any other device that may hold payment account information, such as mobile phones, Smartphones, personal digital assistants (PDAs), key fobs, and/or computers. Each type of payment card can be used as a method of payment for performing a transaction.

In the following description, a digital wallet is a digital wallet account that can be used by a digital wallet owner for a transaction with a merchant. The digital wallet is usually linked to a digital wallet owner's bank account or a digital wallet owner's payment card. Typically, the payments by digital wallets are facilitated by a different entity such as Google®, Apple®, or Paypal®. Such transactions that are made using the digital wallets are also known as wallet-based transactions.

In the following description, an account holder may refer to either a payment card owner or a digital wallet owner. In specific embodiments, the payment card owner may also be a digital wallet owner. For example, a payment card owner may register his or her payment card to a digital wallet account which qualifies the payment card owner as a digital wallet owner. A customer may refer to a party who initiates a transaction. For a digital wallet transaction, the customer may be known as a digital wallet user. For a payment card transaction, the customer may be known as a payment card user. In some embodiments, the account holder may be a customer who initiates a transaction with a merchant. In one example, the payment card holder may initiate the transaction with the merchant to buy goods and/or services (or known as “products”) from the merchant using his or her payment card. In this example, the account holder is the customer. In other words, the account holder may not be the customer. In another example, the customer may initiate the transaction with one merchant to buy products from another merchant using his digital wallet. In an embodiment, the transaction is a payment transaction. In other words, completion or settlement of the transaction involves a payment between parties to the transaction. In embodiments of the present disclosure, the transactions are wallet-based transactions. The computer-implemented method determines if a current wallet-based transaction initiated by a digital wallet user is fraudulent. In an embodiment, a current wallet-based transaction is determined to be fraudulent if the digital wallet user is not the true digital wallet owner. The current wallet-based transaction may only be completed if the current wallet-based transaction is determined to be not fraudulent. In other words, the current wallet-based transaction may only be completed if the digital wallet user is the true digital wallet owner.

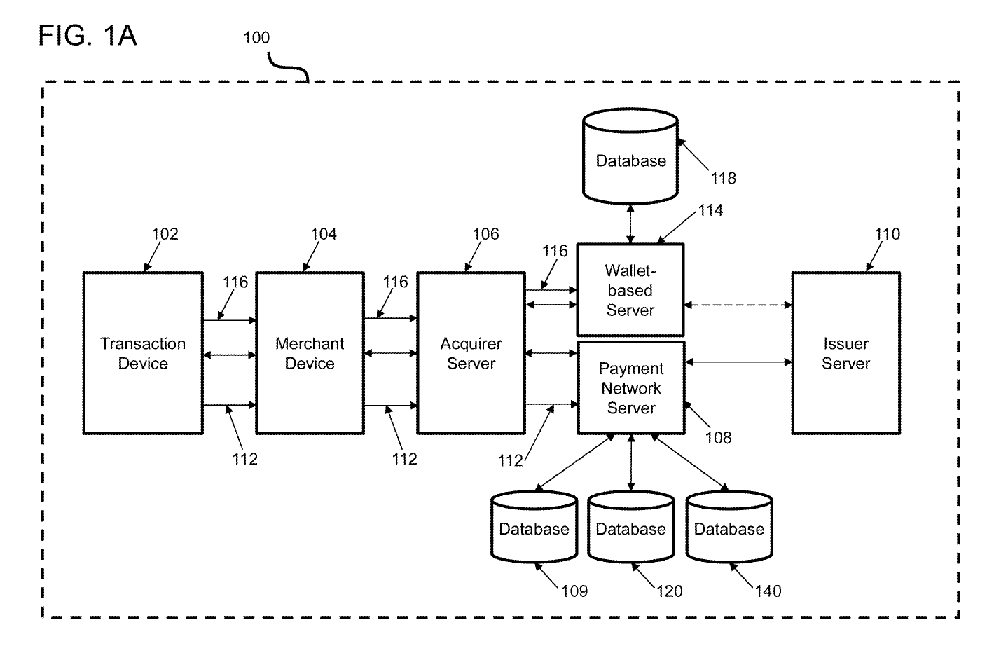

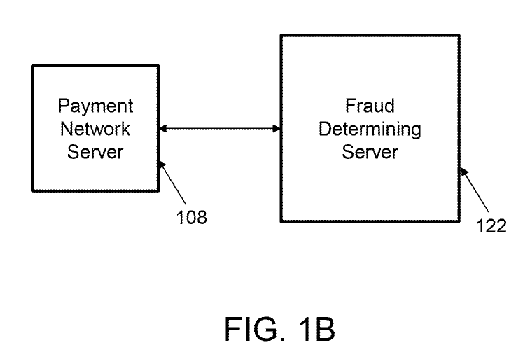

FIG. 1A illustrates a block diagram of a transaction system 100 within which transaction data can be received. The system 100 includes a transaction device 102 in communication with a merchant device 104. The transaction device 102 may also be in direct communication with a payment network server 108, without having to communicate with the merchant device 104. In specific embodiments, the transaction device 102 may also be in direct communication with a wallet-based network server 114, without having to communicate with the merchant device 104.

The merchant device 104 is in communication with an acquirer server 106. The acquirer server 106, in turn, is in communication with the payment network server 108 and the wallet-based network server 114. The payment network server 108, in turn, is in communication with an issuer server 110. In specific embodiments, the acquirer server 106 may also be in communication with the wallet-based network server 114 which is in communication with the issuer server 110.

Use of the term ‘server’ herein can mean a single computing device or a plurality of interconnected computing devices which operate together to perform a particular function. That is, the server may be contained within a single hardware unit or be distributed among several or many different hardware units.

The transaction device 102 typically is associated with a customer who is a party to a transaction that occurs between the transaction device 102 and the merchant device 104 through a transaction. The transaction device 102 may be a fixed (wired) computing device or a wireless (portable) computing device. In specific implementations, the transaction device 102 may be a handheld or portable or mobile device carried or used by the customer, or may refer to other types of electronic devices such as a personal computer, a land-line telephone, an interactive voice response (IVR) system, and the like. The mobile device may be a device, such as a mobile phone, a laptop computer, a personal digital computer (PDA), a mobile computer, a portable music player (such as an iPod™), and the like. The transaction device 102 may be configured to initiate at least one of a payment card transaction or a wallet-based transaction. The transaction device 102 may also be known as a digital wallet device.

The merchant device 104 is typically associated with the merchant who is also a party to the transaction that occurs between transaction device 102 and the merchant device 104 through the transaction. The merchant device 104 may be a point-of-sale (POS) terminal, an automatic teller machine (ATM), a personal computer, a computer server (hosting a website, for example), an IVR system, a land-line telephone, or any type of mobile device such as a mobile phone, a personal digital assistant (PDA), a laptop computer, a tablet computer, and the like.

The acquirer server 106 generally is associated with an acquirer who may be an entity (e.g. a company or organization) which issues (e.g. establishes, manages, administers) a transaction credential or an account (e.g. a financial bank account) of the merchant. Examples of the acquirer include a bank and/or other financial institution. As stated in the above, the acquirer server 106 may include one or more computing devices that are used to establish communication with another server by exchanging messages with and/or passing information to the other server.

The payment network server 108 typically is associated with a payment facilitator. For example, the payment network server 108 may be the Banknet® network operated by MasterCard®. Although depicted and described in the singular, in practice the payment network server 108 will generally be implemented as a plurality of networked servers. The payment facilitator (e.g. MasterCard®) may be an entity (e.g. a company or organization) who operates to process transactions, clear and settle funds for payments between two entities (e.g. two banks). The payment network server 108 may include one or more computing devices that are used for processing transactions.

The wallet-based network server 114 typically is associated with a wallet-based facilitator. For example, the wallet-based network server 108 may be a server operated by Google®, Apple®, Paypal®, or MasterCard®. The wallet-based facilitator (e.g. Google®, Apple®, or Paypal®) may be an entity (e.g. a company or organization) who operates to process wallet-based transactions, clear and settle funds for payments between two entities (e.g. two banks) in a wallet-based environment. The wallet-based network server 114 may include one or more computing devices that are used for processing transactions.

The issuer server 110 generally is associated with an issuer and may include one or more computing devices that are used to perform a payment transaction. The issuer may be an entity (e.g. a company or organization) which issues (e.g. establishes, manages, administers) a transaction credential or an account (e.g. a financial bank account). An account may be associated with a plurality of transaction devices 102.

The payment network server 108 may be configured to communicate with, or may include, a database (or a transaction database) 109. The transaction database 109 stores data corresponding to a transaction (or transaction data). Examples of the data include Transaction ID, Merchant ID, Merchant Name, MCC/Industry Code, Industry Description, Merchant Country, Merchant Address, Merchant Postal Code, Aggregate Merchant ID. For example, data (“Merchant name” or “Merchant ID”) relating to the merchant, time and date for which the goods/services relating to the transaction will be delivered are included in the database 109. In other embodiments, the payment network server 108 may also be configured to communicate with, or may include, another database 140. The database 140 may include data corresponding to a payment card owner. Examples of the data include name, age group, income group, address, gender, or the like relating to the payment card owner.

In an embodiment, the payment network server 108 may be configured to communicate with, or may include, a third party database 120. The third party database 120 may store third party data associated with the payment card owner. An example of a third party is a global information service company (e.g., Experian PLC). Examples of the third party data, includes but not limited to, profile information relating to the payment card owner.

The transaction device 102 is capable of wireless communication using a suitable protocol with the merchant device 104. For example, embodiments may be implemented using transaction devices 102 that are capable of communicating with WiFi/Bluetooth-enabled merchant devices 104. It will be appreciated by a person skilled in the art that depending on the wireless communication protocol used, appropriate handshaking procedures may need to be carried out to establish communication between the transaction device 102 and the merchant device 104. For example, in the case of Bluetooth communication, discovery and pairing of the transaction device 102 and the merchant device 104 may be carried out to establish communication.

In an example, during a payment card transaction, a transaction request message 112 is generated at the transaction device 102. The transaction request message 112 is generated by the transaction device 102 in response to the customer making a selection of a good and/or service to be purchased from the merchant. In other words, the transaction request message 112 relates to a transaction between the customer and the merchant. The transaction may be performed via a website of the merchant. In specific implementations, transaction device 102 may be fitted with a wireless communications interface, such as a Near Field Communication (NFC) interface to enable the transaction device 102 to electronically communicate with the merchant device 104 to perform the transaction. NFC is a set of standards to establish radio communication between devices by bringing them into close proximity such as only a few centimeters. NFC standards cover communication protocols and data exchange formats, and are based on radio-frequency identification (RFID) technology.

The transaction request message 112 may include an indicator relating to the transaction device 102 and/or transaction data. Each transaction data relates to a transaction and identifies the payment card owner and the merchant, generally by way of identifiers of each associated with the payment card owner and merchant respectively. Further, the transaction data may also identify the good and/or service to be purchased and a type or nature of the transaction. The transaction data may further identify a value or price of the good and/or service (e.g., a transaction amount) and a location where the good and/or service will be delivered. The transaction data may also indicate a time and date at which the transaction was initiated by the payment card owner.

The wallet-based network server 114 may be configured to communicate with, or may include, a database 118. The database 118 stores data corresponding to each digital wallet registered by the digital wallet owner and data corresponding to a transaction. Examples of the data include data relating to the payment card used to register the digital wallet. In an embodiment, a list listing digital wallet devices authorized to initiate a wallet-based transaction may be stored.

In another example, during a wallet-based transaction, a wallet-based transaction request message 116 is generated at the transaction device 102. The wallet-based transaction request message 116 is generated by the transaction device 102 in response to the customer (or digital wallet owner) making a selection of a good and/or service to be purchased from the merchant. In other words, the wallet-based transaction request message 116 relates to a wallet-based transaction between the digital wallet owner and the merchant. The transaction may be performed via a website of the merchant. Similar to the transaction request message 112, the wallet-based transaction message 116 may include an indicator relating to the transaction device and/or the transaction data.

The following types of transaction data may be included in the transaction request message 112 or the wallet-based transaction request message 116, which can be generated and captured in transaction databases 109, 118, respectively, when a payment card transaction or a wallet-based transaction is initiated:

Transaction information:
Transaction ID
Account ID (anonymized)
Merchant ID
Transaction Amount
Transaction Local Currency Amount
Date of Transaction
Time of Transaction
Type of Transaction
Date of Processing
Cardholder Present Code
Merchant Category Code (MCC)

Account (or Profile) Information:
Account ID (anonymized)
Card Group Code
Card Product Code
Card Product Description
Card Issuer Country
Card Issuer ID
Card Issuer Name
Aggregate Card Issuer ID
Aggregate Card Issuer Name

Merchant Information:
Merchant ID
Merchant Name
MCC/Industry Code
Industry Description
Merchant Country
Merchant Address
Merchant Postal Code
Aggregate Merchant ID
Aggregate Merchant Name
Merchant Acquirer Country
Merchant Acquirer ID

Issuer Information:
Issuer ID
Issuer Name
Aggregate Issuer ID
Issuer Country

The transaction request message 112 or the wallet-based transaction request message 116 is sent from the transaction device 102 to the merchant device 104. In a disclosed embodiment, for example, where the transaction is being performed at the website of the merchant, the transaction device 102 and the merchant device 104 are in communication with a network, such as, the Internet (not shown for the sake of simplicity). In this example, the transaction request message 112 or the wallet-based transaction request message 116 is sent from the transaction device 102 to the merchant device 104 via the network.

As mentioned above, the role of the payment network server 108 or the wallet-based network server 114 is to facilitate communication between the acquirer server 106 and the issuer server 110. Therefore, the payment network server 108 or the wallet-based network server 114 may serve as a means through which the acquirer server 106 may communicate with the issuer server 110 in a manner that payments and authentication may be performed. In specific implementations, the payment network server 108 or the wallet-based network server 114 receives transaction data when settling a transaction for a consumer and subsequently store/update the transaction data in the database 109 or the database 118, respectively.

The wallet-based network server 114 may be different and separate from the payment network server 108. In specific implementations, the payment network server 108 is further configured to perform additional operations. For example, the payment network server 108 may be configured to update the database 109 whenever a payment card owner registers his payment card to a digital wallet account. Additionally, the payment network server 108 may also be configured to determine if a current wallet-based transaction is fraudulent. In the following description, “current transaction” refers to a transaction that is initiated by a user (or customer), which is meant to be differentiated from “historical transactions” which relates to transactions that were already settled or initiated prior to the current transaction. That is, a “current wallet-based transaction” refers to a wallet-based transaction that is being settled which is meant to be differentiated from “historical wallet-based transactions” which relates to wallet-based transactions that were already settled or initiated prior to the current wallet-based transaction. By the same token, a “current payment card transaction” refers to a payment card transaction that is initiated by a digital wallet user which is meant to be differentiated from “historical payment card transactions” which relates to payment card transactions that were already settled or initiated prior to the current payment card transaction.

For example, if one would like to determine if a current wallet-based transaction is fraudulent, the payment network server 108 is configured to retrieve historical payment card transaction data based on the current wallet-based transaction data and compare the current wallet-based transaction data and historical payment transaction data. Current wallet-based transaction data is related to the current wallet-based transaction and historical wallet-based transaction data is related to the historical wallet-based transactions. Both the current wallet-based transaction data and historical payment transaction data may include transaction information, account (or profile) information, merchant information, issuer information, such as those included in the wallet-based transaction request message 116 and the transaction request 112, respectively, as listed above. The payment network server 108 may include one or more computing devices that are used for processing transactions.

The transaction authorization process described above involves multiple parties (e.g., account holder, merchant, acquirer, issuer, payment facilitator). However, the transaction authorization process may be essentially viewed as a transaction between an account holder and a merchant (with the other parties facilitating the transaction).

FIG. 1B shows how the payment network server 108 may be configured to communicate with a fraud determining server 122 in accordance with an embodiment of the disclosure. The fraud determining server 122 may be associated with an entity different from the payment facilitator. For example, the fraud determining server 122 may be operated by an entity (e.g. a company or organization) that operates to determine which transactions are potentially fraudulent. The payment network server 108 may be configured to perform some or all the functions of the fraud determining server 122. Additionally or alternatively, instead of the payment network server 108, the wallet-based server 114 may be configured to perform some or all the functions of the fraud determining server 122. For example, the fraud determining server 122 may be configured to receive historical payment card transaction data and the current wallet-based transaction data from the payment network server 108 and compare the current wallet-based transaction data and the plurality of historical payment transaction data to determine if the current wallet-based transaction is fraudulent.

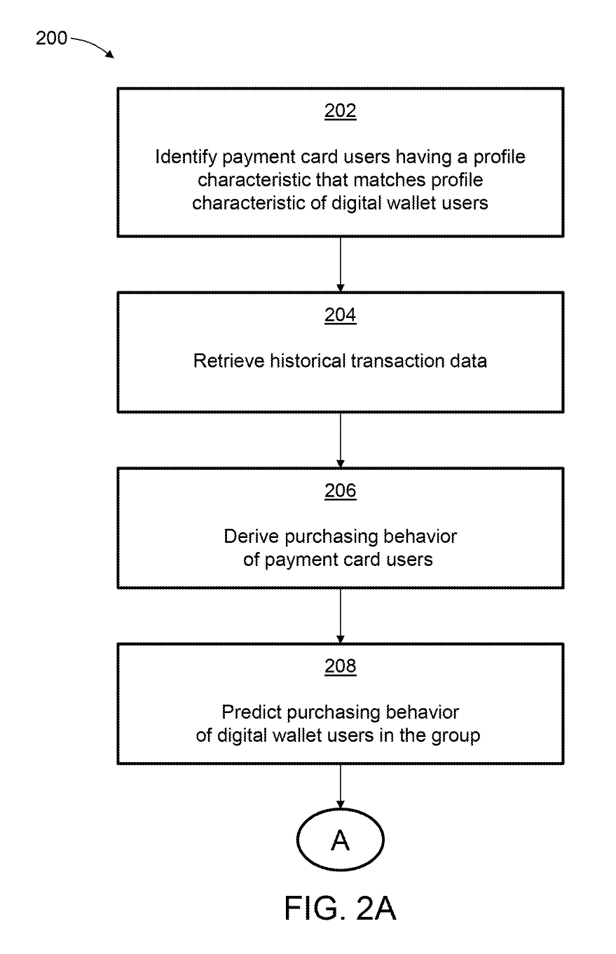

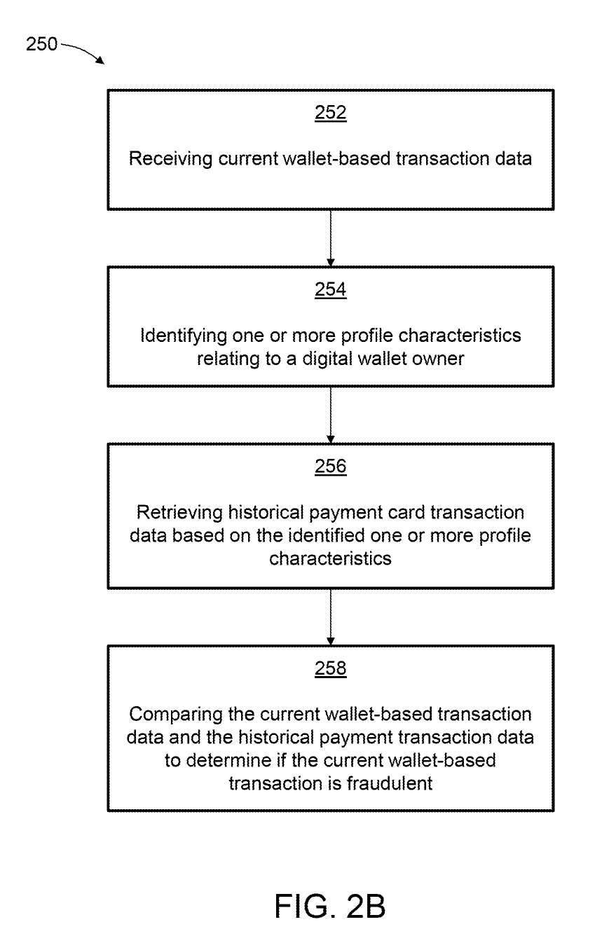

FIG. 2A shows a flow chart 200 illustrating a computer-implemented method for predicting purchasing behavior of digital wallet owners for wallet-based transactions, particularly, the digital wallet owners satisfying a profile characteristic according to an example embodiment. The profile characteristic may refer to, among other things, an age group, a gender group, an income group, and a geographic group. The address included in the profile information gives an indication of a geographical location of the payment card owners.

Referring to FIG. 2A, at step 202, payment card owners who have a profile characteristic that matches the profile characteristic of the digital wallet owner will be identified. This can be done by referring to the profile information of the payment card owners that is registered with the corresponding payment card. In an implementation, the method is implemented to predict the purchasing behavior of the digital wallet owners for wallet-based transactions made by the digital wallet owners who are in a particular age group, for e.g. 25 years old to 30 years old. In this implementation, the profile characteristic is age group. I

n order to do so, the payment network server 108 refers to a database that stores the profile characteristics of the payment card owners so as to identify those who have the profile characteristic that matches the profile characteristic of the digital wallet owners. The profile characteristics of the payment card owners that are stored contains, among other information, the name, age group, income group, address, gender, or the like relating to the payment card owners.

Based on the profile information, a plurality of payment card owners having the profile characteristic that matches that of the digital wallet owners can be identified. For example, a plurality of payment card owners in the age group of 25 years old to 30 years old can be identified by referring to the corresponding age group indicated in each of the profile information. In another example, a plurality of payment card owners in a specific income group, e.g., between $100,000 and $200,000 per annum, can be identified by referring to the corresponding income information indicated in each of the profile information. Each demographic group refers to, among other things, the age, gender, income group of the payment card owners in the group. In a further example, a plurality of payment card owners living in a specific geographical location, e.g., California, U.S.A, can be identified by referring to the corresponding address information indicated in each of the profile information. This step may also be known as segmenting or classifying and each demographic group may be referred as a “segment”.

In an embodiment, the profile information is matched with third party data associated with the payment card owners. In an example, the identified profile information is compared and matched with Experian™ data in order to identify plurality of payment card owners having the profile characteristic that matches that of the digital wallet owners.

Once the payment card owners are identified, historical transaction data relating to a plurality of historical transactions settled for a plurality of payment card owners is retrieved by the payment network server 108 by querying the transaction database 109.

After step 204 is performed, step 206 may be performed. Step 206 involves identifying, from the retrieved historical transaction data, transaction information and merchant information of the identified payment card owners to derive purchasing behavior of the identified plurality of payment card owners. The transaction information includes, among other information, the transaction amount. The transaction amount gives an indication of how much the payment card owners typically spend in each transaction category. Transaction categories can refer to a merchant of a particular industry description or a location of a merchant. This helps to derive the purchasing behavior of the payment card owners.

As mentioned above, the transaction categories include, among other information, the identity of the merchant (e.g., Merchant ID and/or industry description). As such, the merchants with whom the identified payment card owners have made prior transactions can be identified based on the corresponding identities of the merchant in the historical transaction data. This makes it possible to further analyze the types of the merchants with whom the payment card owners tend to initiate transactions. If necessary, various algorithms/rules will be applied to do the analysis.

Additionally or alternatively, the respective locations of the merchants can be obtained by referring to the transaction database 109 having stored thereon the location (e.g. postal address, latitude/longitude) of each merchant in association with the merchant ID. In this context, geographical location data of the merchant may include latitude and longitude coordinates and a postal address. The latitude and longitude coordinates may be in any suitable format, such as: (i) Degrees, minutes, and seconds (DMS), (ii) Degrees and decimal minutes (DMM), and (iii) Decimal degrees (DD). The purchasing behavior of the payment card owners can be identified based on the location of the merchants with whom they have prior transactions.

Typically, customers (e.g. payment card owners and digital card owners) in a specific segment tend to have a similar spending habit or purchasing behavior. That is, the purchasing behavior of the payment card owners for payment card transactions tends to be similar to the purchasing behavior of the digital wallet owners for wallet-based transactions. Based on this assumption, the purchasing behavior of the digital wallet owners for wallet-based transactions can be predicted in step 208 based on the purchasing behavior of the payment card owners.

In specific implementations, the historical transaction data of a plurality of payment card owners are retrieved and analyzed by the payment network server 108. In this way, an individual's particular spending habits are not scrutinized and the anonymity of the payment card owners is maintained. Additionally, the payment network server 108 is configured to use factual and time-sensitive historical transaction data to create segments of one group of consumers (i.e., payment card owners) to recognize purchasing behavior of another group of consumers (i.e., digital wallet owners). The predicted purchasing behavior of the digital wallet owners allows the payment network server 108 to accurately predict their future spending behavior and hence, effectively allocate the resources. Various modifications may be apparent to a person skilled in the art. Instead of the payment network server 108, other servers may retrieve and analyze the historical transaction data. For example, the historical transaction data may be used by the wallet-based sever 114 or the fraud determining server 122 for predicting the spending behavior of the digital wallet owner. In an embodiment, the predicted purchasing behavior may in turn be used to detect potential fraudulent use of the digital wallet.

FIG. 2B shows a flow chart 250 illustrating a computer-implemented method for determining if a current wallet-based transaction initiated by a digital wallet user is fraudulent according to an example embodiment. Referring to step 252, the fraud determining server 122 receives current wallet-based transaction data. The current wallet-based transaction data is generated when a current wallet-based transaction is initiated by the digital wallet user. It should be noted that the “digital wallet user” used in the following description may refer to the digital wallet owner or a person who's initiating a fraudulent transaction.

In an embodiment, the fraud determining server 122 assigns a default fraud score to the current wallet-based transaction. The default fraud score is usually a numerical value, such as “0”, and the value of fraud score is updated based on the analysis of the current wallet-based transaction in one or more determining criteria which will be explained in further detail below with reference to steps 254, 256, and 258. The fraud score may be updated based on the outcome of the determining criteria. Typically, the fraud score is updated only when the current wallet-based transaction is determined to be fraudulent. In any case, the fraud score indicates likelihood that the current wallet-based transaction is fraudulent.

In step 254, the fraud determining server 122 identifies one or more profile characteristics relating to the digital wallet owner. The profile characteristics may be retrieved from the account (or profile) information in the current wallet-based transaction data.

Subsequently, payment card owners satisfying all the profile characteristics relating to the digital wallet owner are identified. As described above with respect to FIG. 2A, the profile characteristics may refer to, among other things, an age group, a gender group, an income group, and a geographic group.

In step 204, the fraud determining server 122 retrieves historical payment card transaction data. These historical payment card transaction data relates to a plurality of historical payment card transactions made by the payment card owners satisfying all of the identified one or more profile characteristics. The information in the historical payment card transaction data, such as transaction information and merchant information, is used to derive purchasing behavior of the identified payment card owners as explained in step 206 with respect to FIG. 2A.

Referring to the description with respect to FIG. 2A, it is assumed that, in the same segment, purchasing behavior of the payment card owner tends to be similar to the purchasing behavior of the digital wallet owner. Based on this assumption, the fraud determining server 122 may compare the current wallet-based transaction data and the plurality of historical payment transaction data. For example, the owners of the same segment tend to spend similar proportion of expenses across different merchant categories. The merchant categories include groceries, apparels, transportation, etc. In other words, a transaction initiated in a category that is outside of the usual merchant categories for a particular segment or overspend in the usual merchant categories will be considered as a transaction outside the purchasing behavior. Various modifications to the purchasing behavior may be apparent to a person skilled in the art. For example, instead of spending in merchant categories, the purchasing behavior can be the amount for the transactions or the items purchased.

The fraud determining server 122 analyzes the current wallet-based transaction data to determine if the current wallet-based transaction matches the corresponding purchasing behavior derived in respect of the identified payment card owners. The fraud score is updated depending on the outcome of the analysis. Specifically, default fraud score is updated after the fraud determining server 122 determines if the transaction is considered as a transaction within the purchasing behavior of the owners of that particular segment. In an embodiment, the digital wallet user is determined to be the digital wallet owner if the current wallet-based transaction matches the corresponding purchasing behavior derived in respect of the identified payment card owners.

Various other determining steps may be carried out before finalizing the fraud score to determine if the current wallet-based transaction is potentially fraudulent. For example, in addition to comparing the current wallet-based transaction to the purchasing behavior of the identified payment card owners, the merchant information associated with the current wallet-based transaction may be obtained to determine if the merchant is authorized to initiate a transaction. For example, an identity of a merchant with whom the digital wallet user has initiated the current wallet-based transaction is obtained. Subsequently, the identity of the merchant is compared with a list of merchants to determine if the current wallet-based transaction is fraudulent. The list of merchants includes merchants who have been identified to be unauthorized to initiate a transaction. That is, a merchant on this list may be known to be a blacklisted merchant. The transaction is considered a fraudulent transaction if the merchant is a blacklisted merchant. The fraud score will be updated according to the reliability of the merchant associated with the current wallet-based transaction.

Additionally or alternatively, the fraud determining server 122 may communicate with the database 118 to retrieve historical wallet-based transaction data of the digital-wallet owner. The historical wallet-based transaction data may include information, such as transaction information and merchant information of the historical wallet-based transactions. The historical wallet-based transaction data may, thus, provide information on the purchasing behavior of the digital wallet owner, such as the merchants with whom the digital wallet owner tend to initiate transactions, the type of products the digital wallet owner inclined to purchase, etc. The fraud determining server 122 analyzes the current wallet-based transaction data to determine if the current wallet-based transaction matches the corresponding purchasing behavior derived from the historical wallet-based transaction data. The fraud score is updated depending on the outcome of the analysis.

In an embodiment, a current product data associated with the current wallet-based transaction may be determined. For example, the current product data may include the category of product that the digital wallet user is purchasing. The product data may be compared with a list of product data which includes products purchased by the digital wallet owner. The list of product data may be obtained from the historical wallet-based transaction data. Upon comparing the current product data and the list of product data including products purchased by the digital wallet owner, the fraud score is updated accordingly. For example, if the current product data does not match the usual products purchased by the digital wallet owner, there is a stronger likelihood of the current wallet-based transaction being a fraudulent transaction.

Further, a number of login attempts for the digital wallet account of the digital wallet owner may be determined to detect potential fraudulent transactions. A higher number of login attempts suggest a greater likelihood that the current wallet-based transaction is fraudulent. In an embodiment, if a number of attempts exceeds a predetermined threshold attempts indicating a likelihood that the current wallet-based transaction is fraudulent, the fraud score is updated, for e.g. a predetermined score is added or subtracted to the fraud score if the number of login attempts exceeds the predetermined threshold attempts. Various modifications will be appreciated by a person skilled in the art. For example, instead of a predetermined threshold attempts, a predetermined score is added or subtracted for each attempts in excess of one attempt.

In yet another embodiment, a geographical location of the wallet-based transactions may be obtained when the transactions are initiated. For example, when the wallet-based transactions are initiated, wallet-based transaction data includes merchant information in which the merchant location where the transaction is initiated may be obtained. Consumers tend to frequent the same merchants and make purchases at the same places. By detecting the location where the current wallet-based transaction is conducted will give an indication as to whether there is any fraud use of the digital wallet. Specifically, if the current wallet-based transaction is conducted at the same geographical location as the past wallet-based transactions, the likelihood of fraud use is lower and vice versa. The fraud score may, thus, be updated based on the location where the current wallet-based transaction takes place.

In addition, a digital wallet owner may register one or more digital wallet devices under his or her digital wallet account such that the registered digital wallet devices are authorized to initiate a wallet-based transaction. Every digital wallet device has an identifier, such as a Unique Device Identifier (UDID), Android device ID, International Mobile Equipment Identity (IMEI) number, Media Access Control (MAC) address, etc. In an embodiment, the information of the type of digital wallet device used for initiating the current wallet-based transaction may be transmitted with the current wallet-based transaction data. The type of digital wallet device used for initiating the current wallet-based transaction is identified and compared with the one or more of digital wallet devices registered previously to determine if the digital wallet device used is authorized to initiate the transaction. Specifically, the identifier of the digital wallet device used for initiating the current wallet-based transaction is identified and compared with the identifiers of the registered digital wallet devices. The fraud score may be updated based on whether the device is authorized to initiate the current wallet-based transaction.

Other determining criteria include, but not limited to, the login duration of the digital wallet account, the age of the digital wallet password, the similarity between the current wallet-based transaction and a previous fraudulent transaction, etc.

After updating the fraud score in one or more determining criteria as described above, the updated fraud score is compared with a predetermined threshold value. The predetermined threshold value may be calculated by assigning weights to selected variables, such as historical transaction data and time. In an embodiment, where the fraud score increases in response to potential fraud use in each determining criteria, the current wallet-based transaction is determined to be a potential fraud use when the updated fraud score is more than the predetermined threshold value. On the other hand, where the fraud score decreases in response to potential fraud use in each determining criteria, the current wallet-based transaction is determined to be a potential fraud use when the updated fraud score is less than the predetermined threshold value.

In an embodiment, if the current wallet-based transaction is determined to be a potential fraud use, the transaction may be blocked. Alternatively, the digital wallet owner may be requested to provide verification input such that the identity of the owner may be verified before the transaction can proceed. For example, when it is determined that the current wallet-based transaction is fraudulent, a verification request may be transmitted to a device authorized to initiate a wallet-based transaction to request for a verification input, such as a password, biometric data, a predetermined answer to a query, etc. If the verification input is correct (e.g. a verification input is correct if it corresponds to an input registered to the digital wallet owner), the current wallet-based transaction will be considered a genuine transaction and allowed to proceed to be settled. Otherwise, the current wallet-based transaction will be considered a fraudulent transaction and the transaction will be refused.

Determining fraudulent use of a digital wallet is important to ensure a safe ecosystem for this payment system. As the payment card and digital wallet owners in different segments have different spending behavior, providing a standard fraud for determining owners in different segments may not be accurate. Embodiments of the present disclosure provide methods for determining if a current wallet-based transaction is fraudulent. The historical payment transaction data related to payment card owners of the same segment as the digital wallet owner are retrieved and the purchasing behaviors of the payment card owners is derived. The current wallet-based transaction is subsequently analyzed to determine the likelihood of it being a fraudulent transaction. As the method uses actual historical data in the analysis which reflects the purchasing behavior of the digital wallet owners, the method for determining fraudulent transaction may be more accurate. As a result, the payment system may also be more efficient as false alarm of fraudulent transactions and the formalities involved in verifying the identity of the owners may reduce significantly.

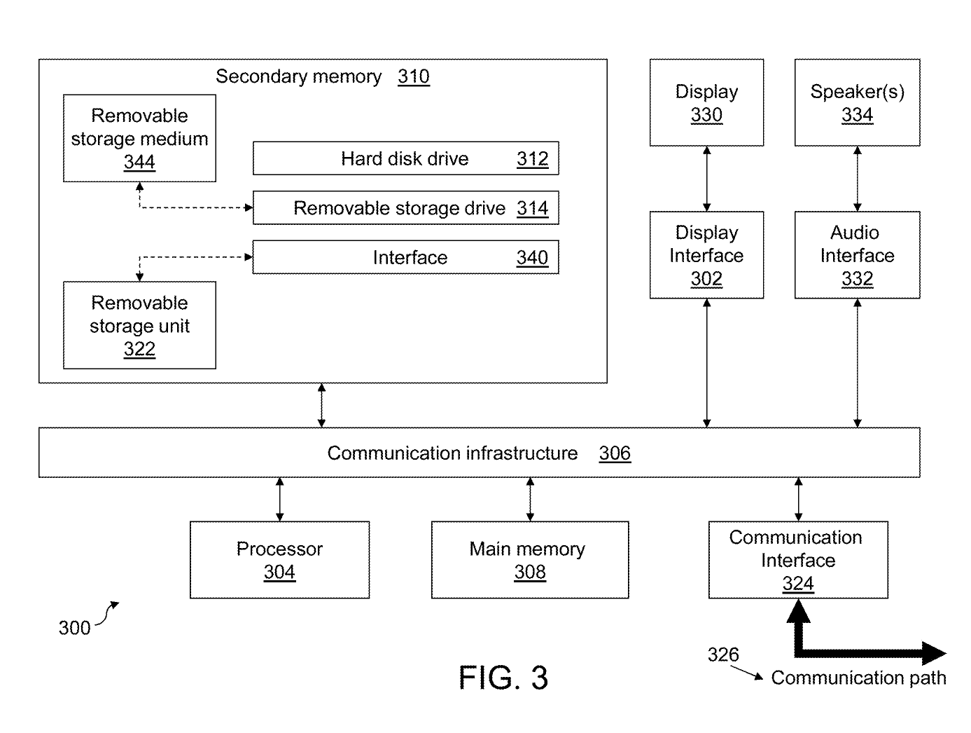

FIG. 3 depicts an exemplary computer/computing device 300, hereinafter interchangeably referred to as a computer system 300, where one or more such computing devices 300 may be used to facilitate execution of the above-described method for determining if a current wallet-based transaction is fraudulent. In addition, one or more components of the computer system 300 may be used to realize the computer 302. The following description of the computing device 300 is provided by way of example only and is not intended to be limiting.

As shown in FIG. 3, the example computing device 300 includes a processor 304 for executing software routines. Although a single processor is shown for the sake of clarity, the computing device 300 may also include a multi-processor system. The processor 304 is connected to a communication infrastructure 306 for communication with other components of the computing device 300. The communication infrastructure 306 may include, for example, a communications bus, cross-bar, or network.

The computing device 300 further includes a main memory 308, such as a random access memory (RAM), and a secondary memory 310. The secondary memory 310 may include, for example, a storage drive 312, which may be a hard disk drive, a solid state drive or a hybrid drive and/or a removable storage drive 314, which may include a magnetic tape drive, an optical disk drive, a solid state storage drive (such as a USB flash drive, a flash memory device, a solid state drive, or a memory card), or the like. The removable storage drive 314 reads from and/or writes to a removable storage medium 344 in a well-known manner. The removable storage medium 344 may include magnetic tape, optical disk, non-volatile memory storage medium, or the like, which is read by and written to by removable storage drive 314. As will be appreciated by persons skilled in the relevant art(s), the removable storage medium 344 includes a computer readable storage medium having stored therein computer executable program code instructions and/or data.

In an alternative implementation, the secondary memory 310 may additionally or alternatively include other similar means for allowing computer programs or other instructions to be loaded into the computing device 300. Such means can include, for example, a removable storage unit 322 and an interface 340. Examples of a removable storage unit 322 and interface 340 include a program cartridge and cartridge interface (such as that found in video game console devices), a removable memory chip (such as an EPROM or PROM) and associated socket, a removable solid state storage drive (such as a USB flash drive, a flash memory device, a solid state drive, or a memory card), and other removable storage units 322 and interfaces 340 which allow software and data to be transferred from the removable storage unit 322 to the computer system 300.

The computing device 300 also includes at least one communication interface 324. The communication interface 324 allows software and data to be transferred between computing device 300 and external devices via a communication path 326. In various embodiments of the disclosure, the communication interface 324 permits data to be transferred between the computing device 300 and a data communication network, such as a public data or private data communication network. The communication interface 324 may be used to exchange data between different computing devices 300 which such computing devices 300 form part an interconnected computer network. Examples of a communication interface 324 can include a modem, a network interface (such as an Ethernet card), a communication port (such as a serial, parallel, printer, GPIB, IEEE 1394, RJ45, USB), an antenna with associated circuitry, and the like. The communication interface 324 may be wired or may be wireless. Software and data transferred via the communication interface 324 are in the form of signals which can be electronic, electromagnetic, optical, or other signals capable of being received by communication interface 324. These signals are provided to the communication interface via the communication path 326.

As shown in FIG. 3, the computing device 300 further includes a display interface 302 which performs operations for rendering images to an associated display 330 and an audio interface 332 for performing operations for playing audio content via associated speaker(s) 334.

As used herein, the term “computer program product” may refer, in part, to removable storage medium 344, removable storage unit 322, a hard disk installed in storage drive 312, or a carrier wave carrying software over communication path 326 (wireless link or cable) to communication interface 324. Computer readable storage media refers to any non-transitory, non-volatile tangible storage medium that provides recorded instructions and/or data to the computing device 300 for execution and/or processing. Examples of such storage media include magnetic tape, CD-ROM, DVD, Blu-ray™ Disc, a hard disk drive, a ROM or integrated circuit, a solid state storage drive (such as a USB flash drive, a flash memory device, a solid state drive, or a memory card), a hybrid drive, a magneto-optical disk, or a computer readable card, such as a SD card, and the like, whether or not such devices are internal or external of the computing device 300. Examples of transitory or non-tangible computer readable transmission media that may also participate in the provision of software, application programs, instructions and/or data to the computing device 300 include radio or infra-red transmission channels as well as a network connection to another computer or networked device, and the Internet or Intranets including e-mail transmissions and information recorded on Websites and the like.

The computer programs (also called computer program code) are stored in main memory 308 and/or secondary memory 310. Computer programs can also be received via the communication interface 324. Such computer programs, when executed, enable the computing device 300 to perform one or more features of embodiments discussed herein. In various embodiments, the computer programs, when executed, enable the processor 304 to perform features of the above-described embodiments. Accordingly, such computer programs represent controllers of the computer system 300.

Software may be stored in a computer program product and loaded into the computing device 300 using the removable storage drive 314, the storage drive 312, or the interface 340. Alternatively, the computer program product may be downloaded to the computer system 300 over the communications path 326. The software, when executed by the processor 304, causes the computing device 300 to perform functions of embodiments described herein.

It is to be understood that the embodiment of FIG. 3 is presented merely by way of example. Therefore, in some embodiments one or more features of the computing device 300 may be omitted. Also, in some embodiments, one or more features of the computing device 300 may be combined together. Additionally, in some embodiments, one or more features of the computing device 300 may be split into one or more component parts.

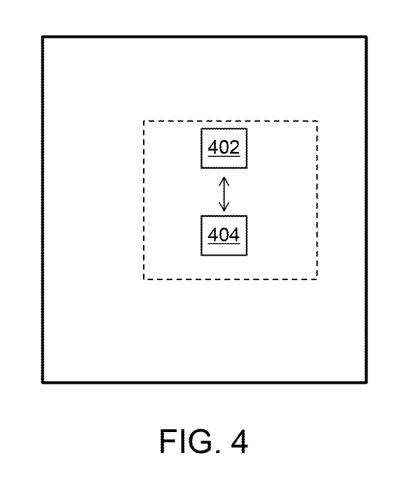

In an implementation, the fraud determining server 122 may be generally described as a physical device including at least one processor 402 and at least one memory 404 including computer program code. The at least one memory 404 and the computer program code are configured to, with the at least one processor 402, cause the physical device to perform the operations described in FIG. 2B. In an implementation, the payment network server 108 and wallet-based server 114 may also be configured to perform the operations of the fraud determining server 122 described in FIG. 2B. An example of the fraud determining server 122 is shown in FIG. 4.

It will be appreciated by a person skilled in the art that numerous variations and/or modifications may be made to the present disclosure as shown in the specific embodiments without departing from the spirit or scope of the disclosure as broadly described. For example, the above description mainly discusses the use of a Bluetooth connection, but it will be appreciated that another type of secure wireless connection, such as Wi-Fi, can be used in alternate embodiments to implement the method. Some modifications, e.g. adding an access point, changing the log-in routine, etc. may be considered and incorporated. The present embodiments are, therefore, to be considered in all respects to be illustrative and not restrictive.

1. A computer-implemented method for determining if a current wallet-based transaction initiated by a digital wallet user is fraudulent, the method comprising:
receiving current wallet-based transaction data relating to the current wallet-based transaction, the current wallet-based transaction data identifying a digital wallet account to be used by the digital wallet user;
identifying one or more profile characteristics relating to a digital wallet owner based on the current wallet-based transaction data, the digital wallet owner being an owner of the identified digital wallet account;
retrieving historical payment card transaction data based on the identified one or more profile characteristics, the historical payment card transaction data relating to a plurality of historical payment card transactions for a plurality of payment card owners satisfying all of the identified one or more profile characteristics and indicating a prediction of a purchasing behavior of the digital wallet owner; and
comparing the current wallet-based transaction data and the historical payment transaction data to determine if the current wallet-based transaction is fraudulent.

2. The method according to claim 1, wherein the step of receiving the current wallet-based transaction data relating to the current wallet-based transaction further comprises assigning a fraud score to the current wallet-based transaction, the fraud score indicating a likelihood that the current wallet-based transaction is fraudulent.

3. The method according to claim 2, wherein the step of comparing the current wallet-based transaction data and historical payment transaction data to determine if the current wallet-based transaction is fraudulent further comprises:
updating the fraud score when the current wallet-based transaction is determined to be fraudulent.

4. The method according to claim 2, wherein the step of comparing the current wallet-based transaction data and historical payment transaction data further comprises comparing the fraud score with a predetermined threshold value.

5. The method according to claim 4, wherein the current wallet-based transaction is determined to be fraudulent when the fraud score is more than the predetermined threshold value.

6. The method according to claim 1, further comprising:
obtaining an identity of a merchant with whom the digital wallet user has initiated the current wallet-based transaction; and
comparing the identity of the merchant with a list of merchants to determine if the current wallet-based transaction is fraudulent, the list of merchants comprising merchants who have been identified to be unauthorized to initiate a transaction.

7. The method according to claim 6, further comprising updating the fraud score when the current wallet-based transaction is determined to be fraudulent.

8. The method according to claim 1, further comprising:
determining current product data associated with the current wallet-based transaction; and
comparing the current product data with a list of product data to determine if the current wallet-based transaction is fraudulent, the list of product data comprising products which have been purchased by the digital wallet owner.

9. The method according to claim 1, further comprising:
determining a number of login attempts for the digital wallet account of the digital wallet owner.

10. The method according to claim 9, further comprising:
identifying a digital wallet device used in the current wallet-based transaction; and
comparing the digital wallet device with one or more digital wallet devices to determine if the current wallet-based transaction is fraudulent, the one or more digital wallet devices comprising devices authorized to initiate a wallet-based transaction on behalf of the digital wallet owner.

11. The method according to claim 10, further comprising:
transmitting a verification request to a digital wallet device included in the one or more digital wallet devices when it is determined that the current wallet based transaction is fraudulent; and
settling the current wallet based transaction based on a verification input.

12. An apparatus for determining if a current wallet-based transaction initiated by a digital wallet user is fraudulent, the apparatus comprising:
at least one processor; and
at least one memory including computer program code;
the at least one memory and the computer program code configured to, with at least one processor, cause the apparatus at least to:
receive current wallet-based transaction data relating to the current wallet-based transaction, the current wallet-based transaction data identifying a digital wallet account to be used by the digital wallet user;
identify one or more profile characteristics relating to a digital wallet owner based on the current wallet-based transaction data, the digital wallet owner being an owner of the identified digital wallet account;
retrieve historical payment card transaction data based on the identified one or more profile characteristics, the historical payment card transaction data relating to a plurality of historical payment card transactions for a plurality of payment card owners satisfying all of the identified one or more profile characteristics and indicating a prediction of a purchasing behavior of the digital wallet owner; and
compare the current wallet-based transaction data and the historical payment transaction data to determine if the current wallet-based transaction is fraudulent.

13. The apparatus according to claim 12, wherein the at least one memory and the computer program code are further configured with the at least one processor to receive the current wallet-based transaction data relating to the current wallet-based transaction further comprises assigning a fraud score to the current wallet-based transaction, the fraud score indicating a likelihood that the current wallet-based transaction is fraudulent.

14. The apparatus according to claim 13, wherein the at least one memory and the computer program code are further configured with the at least one processor to update the fraud score when the current wallet-based transaction is determined to be fraudulent.

15. The apparatus according to claim 13, wherein the at least one memory and the computer program code are further configured with the at least one processor to compare the fraud score with a predetermined threshold value.

16. The apparatus according to claim 15, wherein the current wallet-based transaction is determined to be fraudulent when the fraud score is more than the predetermined threshold value.

17. The apparatus according to claim 12, wherein the at least one memory and the computer program code is are further configured with the at least one processor to:
obtain an identity of a merchant with whom the digital wallet user has initiated the current wallet-based transaction; and
compare the identity of the merchant with a list of merchants to determine if the current wallet-based transaction is fraudulent, the list of merchants comprising merchants who have been identified to be unauthorized to initiate a transaction.

18. The apparatus according to claim 17, wherein the at least one memory and the computer program code are further configured with the at least one processor to update the fraud score when the current wallet-based transaction is determined to be fraudulent.

19. The apparatus according claim 12, wherein the at least one memory and the computer program code is are further configured with the at least one processor to:
determine current product data associated with the current wallet-based transaction; and
compare the current product data with a list of product data to determine if the current wallet-based transaction is fraudulent, the list of product data comprising products which have been purchased by the digital wallet owner.

20. The apparatus according to claim 12, wherein the at least one memory and the computer program code is further configured with the at least one processor to:
determine a number of login attempts for the digital wallet account of the digital wallet owner.

21. The apparatus according claim 12, wherein the at least one memory and the computer program code is further configured with the at least one processor to:
identify a type of a digital wallet device used in the current wallet-based transaction; and
compare the digital wallet device with one or more digital wallet devices to determine if the current wallet-based transaction is fraudulent, the one or more digital wallet devices listing devices authorized to initiate a wallet-based transaction on behalf of the digital wallet owner.

22. The apparatus according to claim 21, wherein the at least one memory and the computer program code are further configured with the at least one processor to:
transmit a verification request to a digital wallet device comprised in the one or more digital wallet devices when it is determined that the current wallet based transaction is fraudulent; and
settle the current wallet based transaction based on a verification input.

23. A computer-readable storage medium having stored thereon computer program code which when executed by a computer causes the computer to execute a method in accordance with claim 1.
